(19) United States
(12) Patent Application Publication
(10) Pub. No.: US 2026/0188554 A1
(43) Pub. Date: Jul. 2, 2026

(54) INDUCTIVE COMPONENT

(71) Applicant: Delta Electronics (Thailand) Public Company Limited, Samutprakarn (TH)

(72) Inventors: Chaiwichit Suraprechakul, Samutprakarn (TH); Jakrapong Wongsasulux, Samutprakarn (TH); Chin Huat Lim, Samutprakarn (TH)

(21) Appl. No.: 19/001,868

(22) Filed: Dec. 26, 2024

(51) Int. Cl. H01F 27/24; H01F 3/14; H01F 27/28

(52) U.S. Cl. CPC H01F 27/24; H01F 3/14; H01F 27/2804

(57) ABSTRACT

The present disclosure provides an inductive component including a first and a second magnetic cores, an inner core and a flat winding portion. The first and second magnetic cores are assembled with each other in opposite orientations and form an enclosed space. The first magnetic core includes a first cap portion and a first side portion, the second magnetic core includes a second cap portion and a second side portion. The inner core is disposed between the first and second magnetic cores and is accommodated in the enclosed space. The inner core includes a body portion and two extruding portions connected. A first gap and a second gap are provided between the two extruding portions and the first cap portion and the second cap portion respectively along a direction parallel to a winding plane of the flat winding portion.

### FIELD OF THE INVENTION

The present disclosure relates to an inductive component, and more particularly to an inductive component with reduced AC loss.

### BACKGROUND OF THE INVENTION

Converters like boost power factor correction (PFC), semi-bridgeless PFC, totem pole PFC, LLC resonant converter are required to operate at high switching frequency. Therefore, high frequency inductor becomes popular for reducing the size of the magnetic components.

When the inductor is operating at high frequency, the power loss that occurs in inductor may be separated into DC loss and AC loss which are caused by DC current and AC current respectively. In the high frequency operation, AC loss caused by Eddy current effect and proximity effect makes non-uniform current flow in conduction. Normally, the impact of the AC loss is greater than that of the DC loss.

In the conventional approach of reducing the AC loss, the Litz wire is utilized to replace the solid cooper wire for winding. However, for the type and the size considerations, the mentioned approach is only suitable for conventional inductor but is not suitable for low-profile inductor or low-profile application.

Therefore, there is a need of providing an inductive component to obviate the drawbacks encountered from the prior arts.

### SUMMARY OF THE INVENTION

It is an object of the present disclosure to provide an inductive component. In the present disclosure, by placing the winding and the core of the inductive component in an enclosed space structure formed by the magnetic cores, the magnetic flux caused by the winding will not be exposed. Therefore, the AC loss due to nearby components is reduced, and the electromagnetic interference (EMI) is prevented. In addition, since the type of the winding is not limited in the present disclosure, the suitable of the inductive component is improved.

In accordance with an aspect of the present disclosure, there is provided an inductive component. The inductive component includes a first magnetic core, a second magnetic core, an inner core and a flat winding portion. The first magnetic core and the second magnetic core are assembled with each other in opposite orientations and form an enclosed space. The first magnetic core includes a first cap portion and a first side portion, the second magnetic core includes a second cap portion and a second side portion, the first side portion and the second side portion are connected to each other, and the first cap portion and the second cap portion are distant to each other. The inner core is disposed between the first magnetic core and the second magnetic core and is accommodated in the enclosed space. The inner core includes a body portion and two extruding portions connected at two opposite ends of the body portion. The flat winding portion is accommodated in the enclosed space and is wound around the body portion of the inner core, wherein a first gap and a second gap are provided between the two extruding portions of the inner core and the first cap portion and the second cap portion respectively along a direction parallel to a winding plane of the flat winding portion.

In an embodiment, the enclosed space includes a main cavity formed by the first side portion and the second side portion and two concave cavities formed at the first cap portion and the second cap portion respectively, the body portion of the inner core is disposed in the main cavity, and the two extruding portions of the inner core are disposed in the two concave cavities respectively.

In an embodiment, the two concave cavities conform with the two extruding portions of the inner core respectively in at least size or shape.

In an embodiment, a second radius of the each of the two concave cavities is smaller than a first radius of the main cavity.

In an embodiment, the first cap portion includes a first concave surface and a first concave wall which together define one of the two concave cavities, the second cap portion includes a second concave surface and a second concave wall which together define the other one of the two concave cavities.

In an embodiment, a third gap and a fourth gap are provided between the two extruding portions of the inner core and the first cap portion and the second cap portion respectively along a direction perpendicular to the winding plane of the flat winding portion.

In an embodiment, the first gap, the second gap, the third gap and the fourth gap form a continuous channel space.

In an embodiment, the first gap and the second gap or the third gap and the fourth gap are filled with insulation material.

In an embodiment, the first cap portion includes a first concave surface and a first concave wall, the second cap portion includes a second concave surface and a second concave wall, and each of the two extruding portions includes an outer surface and an outer wall, and wherein the first gap is formed between the first concave surface and the outer surface of one of the two extruding portions, the second gap is formed between the second concave surface and the outer surface of the other one of the two extruding portions.

In an embodiment, the third gap is formed between the first concave wall and the outer wall of one of the two extruding portions, and the fourth gap is formed between the second concave wall and the outer wall of the other one of the two extruding portions.

In an embodiment, the first cap portion further includes a first edge surface adjacent to the first concave wall and the first side portion, the second cap portion further includes a second edge surface adjacent to the second concave wall and the second side portion, and each of the two extruding portions further includes an inner surface adjacent to the outer wall and the body portion, and wherein the first edge surface is aligned with the inner surface of one of the extruding portions, the second edge surface is aligned with the inner surface of the other one of the extruding portions.

In an embodiment, the inner core includes two inner sub-cores corresponding to the first and second magnetic cores respectively.

In an embodiment, each of the two inner sub-cores includes one of the two extruding portions and a sub-body portion, the two sub-body portions of the two inner sub-cores form the body portion.

In an embodiment, the two sub-body portions are aligned and separated by an air-gap.

In an embodiment, the two sub-body portions are connected to each other.

In an embodiment, the first and second magnetic cores and the two inner sub-cores are assembled in a manner substantially aligned with a virtual plane.

In an embodiment, the body portion and the two extruding portions of the inner core are formed in one piece.

In an embodiment, the inner core is an I core and the flat winding portion is a PCB winding coil.

In an embodiment, there is at least one first hole on the first side portion, and there is at least one second hole on the second side portion, and the first hole of the first magnetic core and the second hole of the second magnetic core form an opening.

In an embodiment, the opening is configured for accommodating an inlet and an outlet of the flat winding portion.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating an inductive component according to an embodiment of the present disclosure;

FIG. 2 is a schematic cross-sectional view of the inductive component in FIG. 1;

FIG. 3 is a schematic cross-sectional view of the first and second magnetic cores in FIG. 1;

FIG. 4 is an exploded view illustrating the inductive component in FIG. 1;

FIG. 5 is an exploded view illustrating the inductive component in FIG. 1 with different view comparing to FIG. 4;

FIG. 6 is a schematic perspective view illustrating an inductive component according to another embodiment of the present disclosure;

FIG. 7 is a schematic cross-sectional view of the inductive component in FIG. 6;

FIG. 8 is an exploded view illustrating the inductive component in FIG. 6;

FIG. 9 is a schematic perspective view illustrating an inductive component according to another embodiment of the present disclosure;

FIG. 10 is an exploded view illustrating the inductive component in FIG. 9;

FIG. 11 is a schematic perspective view illustrating an inductive component according to another embodiment of the present disclosure; and

FIG. 12 is an exploded view illustrating the inductive component in FIG. 11.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

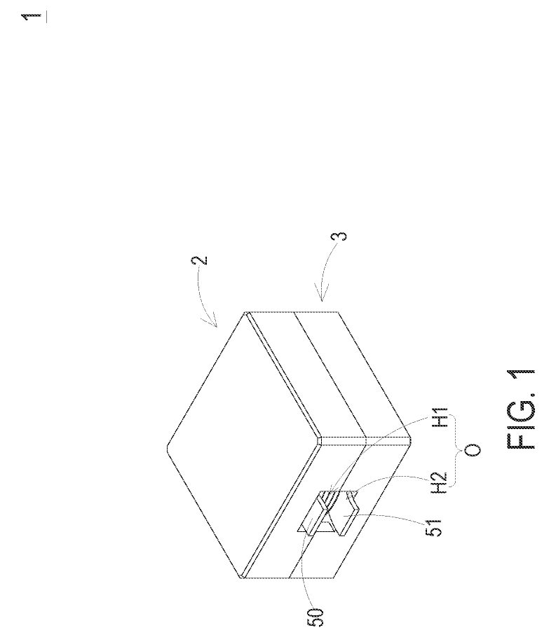

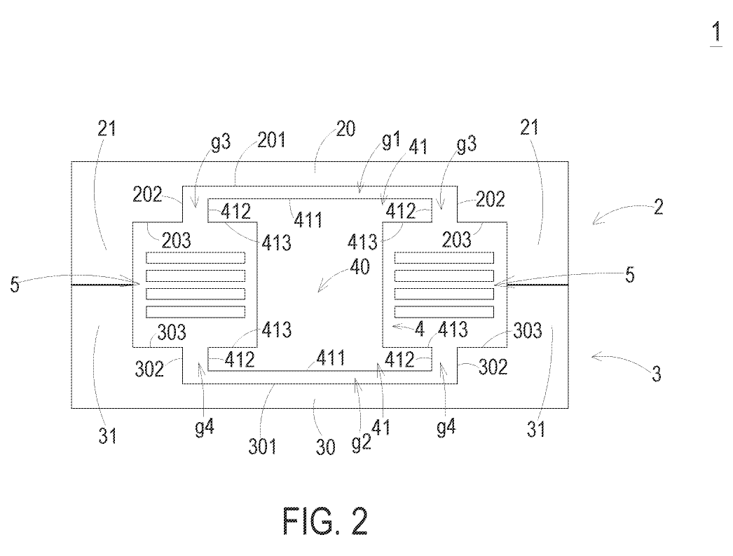

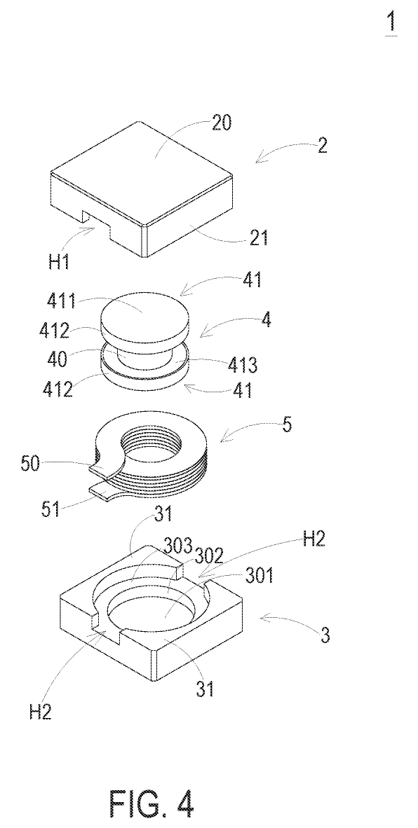

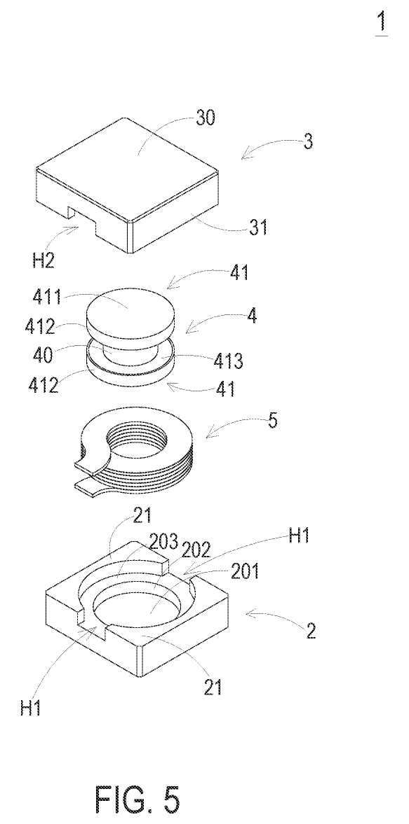

FIG. 1 is a schematic perspective view illustrating an inductive component 1 according to an embodiment of the present disclosure. FIG. 2 is a schematic cross-sectional view of the inductive component 1 in FIG. 1. FIG. 4 is an exploded view illustrating the inductive component 1 in FIG. 1. FIG. 5 is an exploded view illustrating the inductive component 1 in FIG. 1 with different view comparing to FIG. 4. As shown in FIGS. 1, 2, 4 and 5, the inductive component 1 includes a first magnetic core 2, a second magnetic core 3, an inner core 4 and a flat winding portion 5. The first magnetic core 2 and the second magnetic core 3 are assembled with each other in opposite orientations and form an enclosed space. The first magnetic core 2 includes a first cap portion 20 and a first side portion 21, and the first side portion 21 is extended from the first cap portion 20. The second magnetic core 3 includes a second cap portion 30 and a second side portion 31, and the second side portion 31 is extended from the second cap portion 30. The first side portion 21 and the second side portion 31 are connected to each other, and the first cap portion 20 and the second cap portion 30 are distant to each other.

The inner core 4 is disposed between the first magnetic core 2 and the second magnetic core 3 and is accommodated in the enclosed space. The inner core 4 includes a body portion 40 and two extruding portions 41 connected at two opposite ends of the body portion 40. In an embodiment, the inner core 4 is an I core, the body portion 40 and the two extruding portions 41 are cylinders, and the radius of the body portion 40 is less than that of the two extruding portions 41.

The flat winding portion 5 is accommodated in the enclosed space and is wound around the body portion 40 of the inner core 4. The winding direction of the flat winding portion 5 is defined as a winding plane.

There are a plurality of gaps formed between the inner core 4 and the first magnetic core 2 and the second magnetic core 3 respectively, which are shown detailed in FIG. 2. As shown in FIG. 2, a first gap g1 and a second gap g2 are provided between the two extruding portions 41 of the inner core 4 and the first cap portion 20 of the first magnetic core 2 and the second cap portion 30 of the second magnetic core 3 respectively along a direction parallel to the winding plane of the flat winding portion 5. In specific, the first gap g1 is provided between one of the two extruding portions 41 and the first cap portion 20 along the direction parallel to the winding plane of the flat winding portion 5, and the second gap g2 is provided between the other one of the two extruding portions 41 and the second cap portion 30 along the direction parallel to the winding plane of the flat winding portion 5. The type of the inner core 4 and the flat winding portion 5 are not limited. In an embodiment, the inner core 4 is an I core, and the flat winding portion 5 may be a PCB winding coil, a solid flat wire coil or a foil wire coil. In an embodiment, the enclosed space defined by the first magnetic core 2 and the second magnetic core 3 is utilized for preventing the exposing of the magnetic flux caused by the flat winding portion 5.

In the present disclosure, by placing the winding and the core of the inductive component 1 in an enclosed space structure formed by the magnetic cores 2 and 3, the magnetic flux caused by the winding will not be exposed. Therefore, the AC loss of nearby components is reduced, and the electromagnetic interference (EMI) is prevented. In addition, since the type of the winding is not limited in the present disclosure, the suitable of the inductive component 1 is improved.

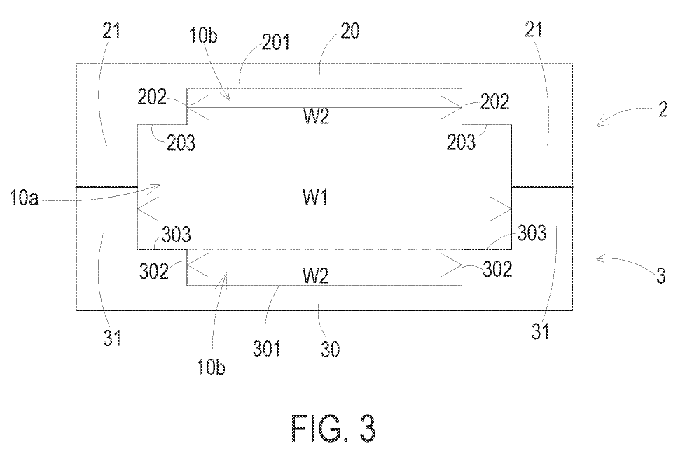

The enclosed space of the present disclosure is described below in detail. Please refer to FIGS. 2 and 3, FIG. 3 is a schematic cross-sectional view of the first magnetic core 2 and the second magnetic core 3 in FIG. 1. The enclosed space includes a main cavity 10a and two concave cavities 10b. The main cavity 10a is formed by the first side portion 21 and the second side portion 31, and the two concave cavities 10b are formed at the first cap portion 20 and the second cap portion 30 respectively. The body portion 40 of the inner core 4 is disposed in the main cavity 10a, and the two extruding portions 41 of the inner core 4 are disposed in the two concave cavities 10b respectively. In an embodiment, the two concave cavities 10b conform with the two extruding portions 41 of the inner core 4 respectively in at least size or shape. In an embodiment, the shapes of the two extruding portions 41 are cylinder, and the two concave cavities 10b are cylindrical spaces capable of conforming the corresponding extruding portions 41. In another embodiment, the shapes of the extruding portions 41 and the corresponding concave cavities 10b are not limited to cylinder and cylindrical space, the only requirement is that the shapes of the extruding portions 41 and the corresponding concave cavities 10b are conforming to each other. In an embodiment, a second radius W2 of the each of the two concave cavities 10b is less than a first radius W1 of the main cavity 10a.

Please refer to FIGS. 2, 3, 4 and 5, the first cap portion 20 includes a first concave surface 201 and a first concave wall 202 surrounding to the first concave surface 201, and the first concave surface 201 and the first concave wall 202 together define one of the two concave cavities 10b. The second cap portion 30 includes a second concave surface 301 and a second concave wall 302 surrounding to the second concave surface 301, and the second concave surface 301 and the second concave wall 302 together define the other one of the two concave cavities 10b.

In addition to the first gap g1 and the second gap g2, there are other gaps formed between the inner core 4 and the first magnetic core 2 and the second magnetic core 3 respectively. Please refer to FIG. 2 again, a third gap g3 and a fourth gap g4 are provided between the two extruding portions 41 of the inner core 4 and the first cap portion 20 and the second cap portion 30 respectively along a direction perpendicular to the winding plane of the flat winding portion 5. Therefore, the extending direction of the first gap g1 and the second gap g2 are perpendicular to that of the third gap g3 and the fourth gap g4. In specific, the third gap g3 is provided between one of the two extruding portions 41 and the first cap portion 20 along the direction perpendicular to the winding plane of the flat winding portion 5, and the fourth gap g4 is provided between the other one of the two extruding portions 41 and the second cap portion 30 along the direction perpendicular to the winding plane of the flat winding portion 5. In an embodiment, the third gap g3 and the fourth gap g4 are communicated to the enclosed space, the third gap g3 is communicated to the first gap g1, and the fourth gap g4 is communicated to the second gap g2.

In an embodiment, the first gap g1, the second gap g2, the third gap g3 and the fourth gap g4 form a continuous channel space. In an embodiment, the first gap g1 and the second gap g2 or the third gap g3 and the fourth gap g4 are filled with insulation material. The insulation material is configured to prevent the inner core 4 from directly connecting to the first magnetic core 2 or the second magnetic core 3. In the embodiment of that the second gap g2 and the fourth gap g4 is filled with the insulation material, the insulation material is disposed between the inner core 4 and the second magnetic core 3 to ensure that the inner core 4 is not directly connected to the second magnetic core 3. In another embodiment, the first gap g1, the second gap g2, the third gap g3 and the fourth gap g4 are filled with insulation material. In embodiments of the present disclosure, the insulation material may be chosen from: epoxy, silicone, Bakelite, ceramic, or insulation sheet such as Nomex®, etc.

The following will specifically define the gaps mentioned in relation to the entity structure of the present disclosure. Please refer to FIGS. 2, 4 and 5, each of the two extruding portions 41 of the inner core 4 includes an outer surface 411 and an outer wall 412 surrounding to the outer surface 411. The first gap g1 is formed between the first concave surface 201 and the outer surface 411 of one of the two extruding portions 41. The second gap g2 is formed between the second concave surface 301 and the outer surface 411 of the other one of the two extruding portions 41.

As regard to the third gap g3 and the fourth gap g4, the third gap g3 is formed between the first concave wall 202 and the outer wall 412 of one of the two extruding portions 41, and the fourth gap g4 is formed between the second concave wall 302 and the outer wall 412 of the other one of the two extruding portions 41.

The first cap portion 20 further includes a first edge surface 203 adjacent to the first concave wall 202 and the first side portion 21, the second cap portion 30 further includes a second edge surface 303 adjacent to the second concave wall 302 and the second side portion 31. Each of the two extruding portions 41 further includes an inner surface 413 adjacent to the outer wall 412 and the body portion 40, and the first edge surface 203 is aligned with the inner surface 413 of one of the extruding portions 41, the second edge surface 303 is aligned with the inner surface 413 of the other one of the extruding portions 41.

There is at least one first hole H1 on the first side portion 21, and there is at least one second hole H2 on the second side portion 31. The first hole H1 of the first magnetic core 2 and the second hole H2 of the second magnetic core 3 form an opening O. In the embodiment shown in FIGS. 1, 4, 5 and 6, there are two first holes H1 disposed on the opposite side of the first side portion 21, and there are two second holes H2 disposed on the opposite side of the second side portion 31. The two first holes H1 are corresponding to the two second holes H2 respectively. The first holes H1 of the first magnetic core 2 and the second holes H2 of the second magnetic core 3 form two openings O on opposite side. In this embodiment, one of the two openings O is configured for accommodating an inlet 50 and an outlet 51 of the flat winding portion 5. In other embodiments of the present disclosure, there can be only one first hole H1 and one second hole H2, forming a single opening O, for accommodating the inlet 50 and outlet 51 at one side of the inductive component 1. Yet in other embodiments of the present disclosure, a first opening O formed by one first hole H1 and one second hole H2 at one side is used for accommodating the inlet 50, and a second opening O formed by another first hole H1 and another second hole H2 at another side is used for accommodating the outlet 51.

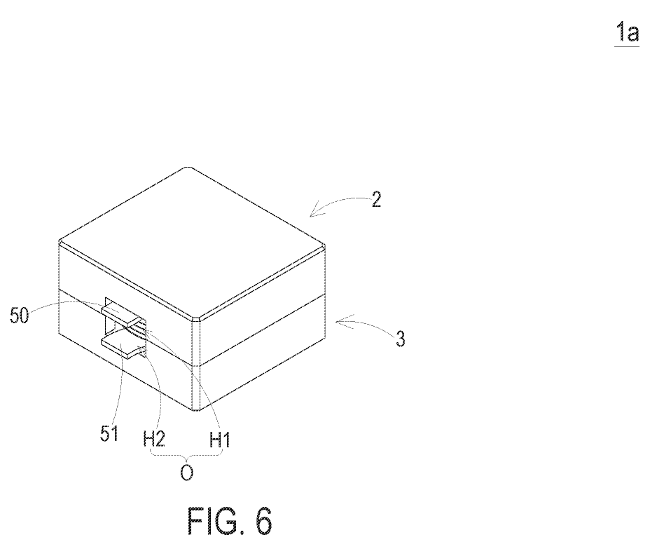

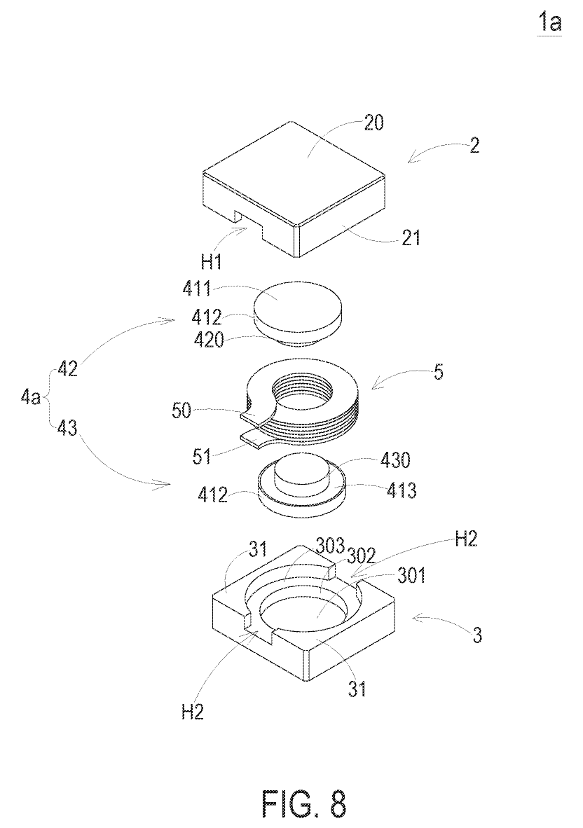

The inner core 4 of the inductive component 1 shown in FIGS. 1 and 2 is formed in one piece. However, the structure of the inner core of the present disclosure is not limited. In specific, the inner core of the present disclosure may be formed in one piece or may be assembled by two parts. Please refer to FIGS. 6, 7 and 8, the embodiment in FIGS. 6, 7 and 8 shows that the inner core 4a of the inductive component 1a is assembled by two parts. The elements with similar structures and functions in the inductive component 1a shown in FIGS. 6, 7 and 8 and the inductive component 1 are denoted by the same reference numerals and will not be described again. In this embodiment, the inner core 4a includes two inner sub-cores 42, 43 corresponding to the first magnetic core 2 and the second magnetic core 3 respectively. Each of the two inner sub-cores 42, 43 includes one of the two extruding portions 41 and one of two sub-body portions 420, 430, the two sub-body portions 420, 430 of the two inner sub-cores 42, 43 form the body portion 40. In specific, the inner sub-core 42 includes one of the two extruding portions 41 and the sub-body portion 420, and the inner sub-core 43 includes the other one of the two extruding portions 41 and the sub-body portion 430. The two sub-body portions 420, 430 are aligned and separated by an air-gap g5. In an embodiment, the distance of the air-gap g5 is significantly less than that of the first gap g1, the second gap g2, the third gap g3 and the fourth gap g4. In an embodiment, the distance of the air-gap g5 is so tiny that can be neglected. In an embodiment, the first and second magnetic cores 2, 3 and the two inner sub-cores 42, 43 are assembled in a manner substantially aligned with a virtual plane. To be noted that in the embodiment shown in FIGS. 1 and 2, it can be regarded as that the two sub-body portions 420, 430 are connected to each other to form the body portion 40.

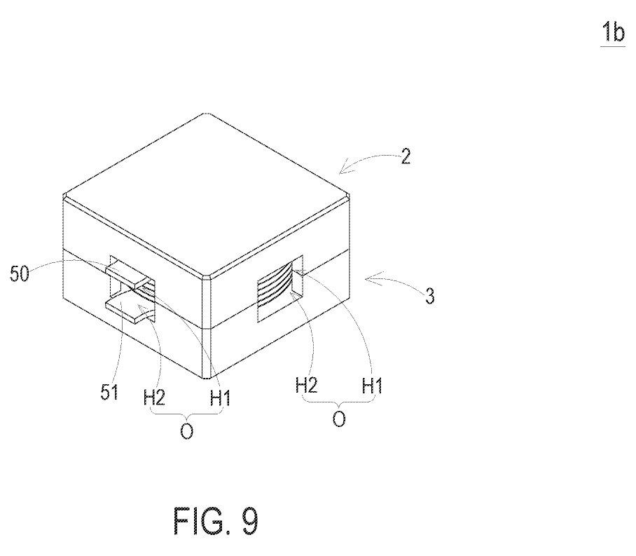

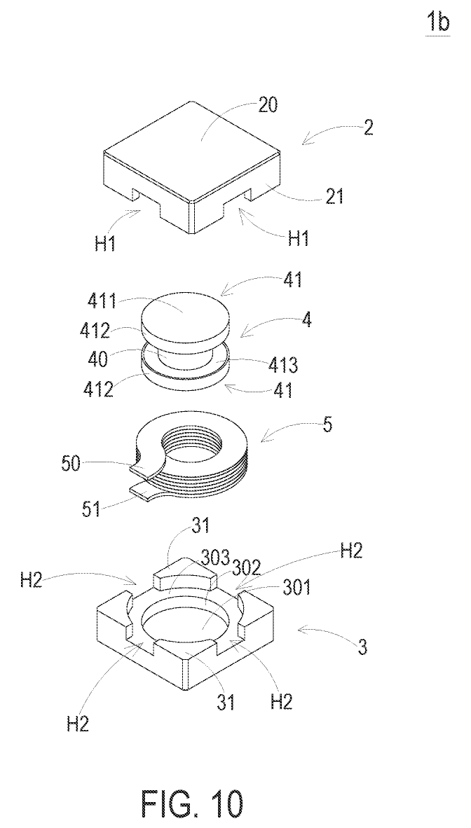

In the previous embodiment, the number of the first holes H1 and the second holes H2 is two, so the number of the opening O is two correspondingly. However, the number of the first hole H1, the second hole H2 and the opening O of the present disclosure are not limited. In addition, the structure of the inner core of the present disclosure is also not limited. The implementation of the number of the first holes H1, the second holes H2 and the openings O equaling four, and the inner core forming in one piece is exemplified as follow. Please refer to FIGS. 9 and 10, in this embodiment, there are four first holes H1 on four sides of the first side portion 21 respectively, and there are four second holes H2 on four sides of the second side portion 31 respectively. The elements with similar structures and functions in the inductive component 1b shown in FIGS. 9 and 10 and the inductive components 1 and 1a are denoted by the same reference numerals and will not be described again. In this embodiment, the four first holes H1 of the first magnetic core 2 and the four second holes H2 of the second magnetic core 3 form four openings O, and one of the four openings O is for accommodating the inlet 50 and the outlet 51 of the flat winding portion 5. In this embodiment, the inner core 4 formed in one piece is the same as the inner core 4 in the embodiment shown in FIGS. 1 and 2, and the detailed descriptions thereof are omitted herein.

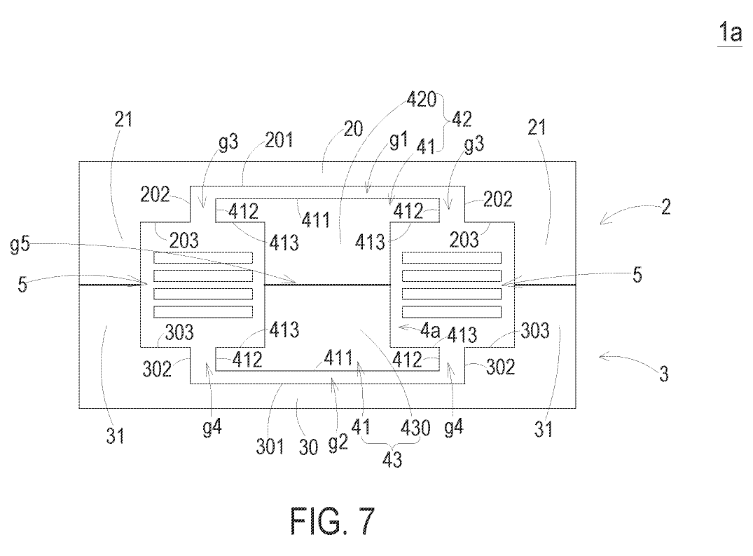

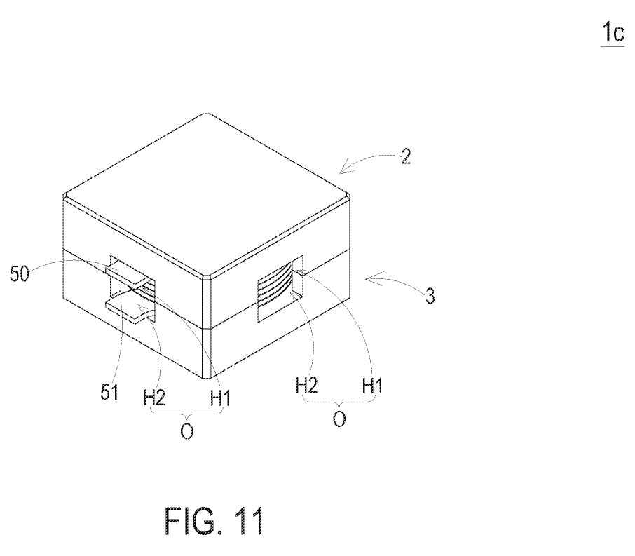

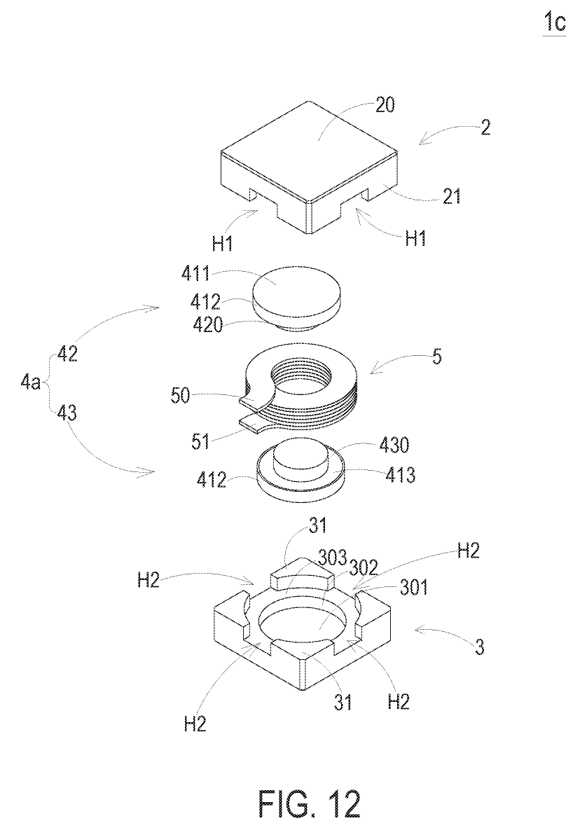

The implementation of the number of the first holes H1, the second holes H2 and the openings O equaling four, and the inner core forming by two parts is exemplified as follow. Please refer to FIGS. 11 and 12, in this embodiment, there are four first holes H1 on four sides of the first side portion 21 respectively, and there are four second holes H2 on four sides of the second side portion 31 respectively. The elements with similar structures and functions in the inductive component 1c shown in FIGS. 11 and 12 and the inductive components 1, 1a and 1b are denoted by the same reference numerals and will not be described again. In this embodiment, the four first holes H1 of the first magnetic core 2 and the four second holes H2 of the second magnetic core 3 form four openings O, one of the four openings O is for accommodating the inlet 50 and the outlet 51 of the flat winding portion 5. In this embodiment, the inner core 4a is formed by two parts, the inner core 4a formed by two parts is the same as the inner core 4a of the embodiment shown in FIGS. 6 and 7, and the detailed descriptions thereof are omitted herein. In other embodiments of the present disclosure, the inlet 50 and outlet 51 may extend out from different openings O. Yet in other embodiments of the present disclosure, the openings O may be used to accommodate other terminals, such as thermal terminals for dissipating heat, or be used as air tunnels for cooling purpose.

In an embodiment, the inductive components 1, 1a, 1b and 1c of the present application is suitable for low-profile inductor or low-profile application. In an embodiment, the inductive components 1, 1a, 1b and 1c of the present application is suitable in converters, like boost power factor correction (PFC), semi-bridgeless PFC, totem pole PFC, LLC resonant converter or etc.

From the above descriptions, the present disclosure provides an inductive component. By placing the winding and the core of the inductive component in an enclosed space structure formed by the magnetic cores, the magnetic flux caused by the winding will not be exposed. Therefore, the AC loss of nearby components is reduced, and the electromagnetic interference (EMI) is prevented. In addition, since the type of the winding is not limited in the present disclosure, the suitable of the inductive component is improved.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An inductive component, comprising:
a first magnetic core and a second magnetic core, assembled with each other in opposite orientations and forming an enclosed space, wherein the first magnetic core comprises a first cap portion and a first side portion, the second magnetic core comprises a second cap portion and a second side portion, the first side portion and the second side portion are connected to each other, and the first cap portion and the second cap portion are distant to each other;
an inner core, disposed between the first magnetic core and the second magnetic core and accommodated in the enclosed space, comprising a body portion and two extruding portions connected at two opposite ends of the body portion; and
a flat winding portion, accommodated in the enclosed space and wound around the body portion of the inner core,
wherein a first gap and a second gap are provided between the two extruding portions of the inner core and the first cap portion and the second cap portion respectively along a direction parallel to a winding plane of the flat winding portion.

2. The inductive component according to claim 1, wherein the enclosed space comprises a main cavity formed by the first side portion and the second side portion and two concave cavities formed at the first cap portion and the second cap portion respectively, the body portion of the inner core is disposed in the main cavity, and the two extruding portions of the inner core are disposed in the two concave cavities respectively.

3. The inductive component according to claim 2, wherein the two concave cavities conform with the two extruding portions of the inner core respectively in at least size or shape.

4. The inductive component according to claim 3, wherein a second radius of the each of the two concave cavities is smaller than a first radius of the main cavity.

5. The inductive component according to claim 2, wherein the first cap portion comprises a first concave surface and a first concave wall which together define one of the two concave cavities, the second cap portion comprises a second concave surface and a second concave wall which together define the other one of the two concave cavities.

6. The inductive component according to claim 1, wherein a third gap and a fourth gap are provided between the two extruding portions of the inner core and the first cap portion and the second cap portion respectively along a direction perpendicular to the winding plane of the flat winding portion.

7. The inductive component according to claim 6, wherein the first gap, the second gap, the third gap and the fourth gap form a continuous channel space.

8. The inductive component according to claim 6, wherein the first gap and the second gap or the third gap and the fourth gap are filled with insulation material.

9. The inductive component according to claim 6, wherein the first cap portion comprises a first concave surface and a first concave wall, the second cap portion comprises a second concave surface and a second concave wall, and each of the two extruding portions comprises an outer surface and an outer wall, and wherein the first gap is formed between the first concave surface and the outer surface of one of the two extruding portions, the second gap is formed between the second concave surface and the outer surface of the other one of the two extruding portions.

10. The inductive component according to claim 9, wherein the third gap is formed between the first concave wall and the outer wall of one of the two extruding portions, and the fourth gap is formed between the second concave wall and the outer wall of the other one of the two extruding portions.

11. The inductive component according to claim 9, wherein the first cap portion further comprises a first edge surface adjacent to the first concave wall and the first side portion, the second cap portion further comprises a second edge surface adjacent to the second concave wall and the second side portion, and each of the two extruding portions further comprises an inner surface adjacent to the outer wall and the body portion, and wherein the first edge surface is aligned with the inner surface of one of the extruding portions, the second edge surface is aligned with the inner surface of the other one of the extruding portions.

12. The inductive component according to claim 1, wherein the inner core comprises two inner sub-cores corresponding to the first and second magnetic cores respectively.

13. The inductive component according to claim 12, wherein each of the two inner sub-cores comprises one of the two extruding portions and a sub-body portion, the two sub-body portions of the two inner sub-cores form the body portion.

14. The inductive component according to claim 13, wherein the two sub-body portions are aligned and separated by an air-gap.

15. The inductive component according to claim 13, wherein the two sub-body portions are connected to each other.

16. The inductive component according to claim 12, wherein the first and second magnetic cores and the two inner sub-cores are assembled in a manner substantially aligned with a virtual plane.

17. The inductive component according to claim 1, wherein the body portion and the two extruding portions of the inner core are formed in one piece.

18. The inductive component according to claim 1, wherein the inner core is an I core and the flat winding portion is a PCB winding coil.

19. The inductive component according to claim 1, wherein there is at least one first hole on the first side portion, and there is at least one second hole on the second side portion, and the first hole of the first magnetic core and the second hole of the second magnetic cores form an opening.

20. The inductive component according to claim 19, wherein the opening is configured for accommodating an inlet and an outlet of the flat winding portion.
